(19) United States
(12) Patent Application Publication
(10) Pub. No.: US 2023/0339027 A1
(43) Pub. Date: Oct. 26, 2023

(54) MINI CUTTING BIT

(71) Applicant: HAO JUEN TECHNOLOGY CO., LTD., Taichung (TW)

(72) Inventors: SHINN LIANG CHANG, Yunlin County (TW); TZU CHI CHAN, Yunlin County (TW); MENG HUA LI, Yunlin County (TW); I HUNG WANG, Taichung (TW)

(21) Appl. No.: 18/193,310

(22) Filed: Mar. 30, 2023

(30) Foreign Application Priority Data
Apr. 26, 2022 (TW) 111204273

(51) Int. Cl. B23B 51/00

(52) U.S. Cl. CPC B23B 51/011; B23B 2251/04

(57) ABSTRACT

A mini cutting bit includes a shank, a cutting part and a bit tip, wherein the cutting part has opposite ends connected to the shank and the bit tip. The bit tip and the cutting part are made of different materials, and the bit tip is harder than the cutting part.

### BACKGROUND OF THE INVENTION

### 1. Technical Field

The present invention relates to a cutter of a machine tool, and more particularly to a mini cutting bit, which has a small size, a high cutting performance, and a long product's life by a structure of a superhard material.

### 2. Description of Related Art

A conventional cutting bit for a machine tool is large to cut workpieces in a low speed. However, large cutters are not applicable to a complex task. Now a day, the cutting tasks are virous and sizes of workpiece is getting small, so the cutters must change to meeting the modern tasks. Therefore, people reconsidered to provide cutting bits with a small size to enhance cutting performance. As a result, mini cutting bits are provided in the market.

Poor chip removal is another reason that causes the mini cutting bits damaged. In practices, the mini cutting bits are damaged by poor chip removal more than by improper cutting parameters. Compared to a large cutting bit, the mini cutting bits are lighter and brittle. So, how to strengthen the mini cutting bits is an important issue to the manufacturers.

### BRIEF SUMMARY OF THE INVENTION

In view of the above, the primary objective of the present invention is to provide a mini cutting bit, which has a great strength thereof to elongate the product's life and make the cutting task safer.

In order to achieve the objective of the present invention, a mini cutting bit includes a shank, a cutting part connected to an end of the shank, and a bit tip connected to an end of the cutting part opposite to the shank. The bit tip and the cutting part are made of different materials, and the bit tip is harder than the cutting part.

In an embodiment, the bit tip has a first cutting portion and a second cutting portion; the first cutting portion is connected to an end of the second cutting portion and is proximal to a front end of the bit tip than the second cutting portion; the first cutting portion has a first cutting angle while the second cutting portion has a second cutting angle; the first cutting portion is greater than the second cutting angle.

In an embodiment, the first cutting angle is 137 degrees, and the second cutting angle is 92 degrees.

In an embodiment, the bit tip further has a third cutting portion connected to an end of the second cutting portion opposite to the first cutting portion; the third cutting portion has a third cutting angle, and the second cutting angle is greater than the third cutting angle.

In an embodiment, the second cutting angle is 92 degrees.

In an embodiment, the shank has a conical portion, and the conical portion has a taper angle; the taper angle is 47 degrees.

In an embodiment, the cutting part has a first spiral portion and a second spiral portion parallelly and twistedly formed on the cutting part; the first spiral portion has a helix angle, and the helix angle is 32 degrees.

In an embodiment, the shank and the cutting part are made of a single element.

In an embodiment, the cutting part and the shank are made of tungsten carbide alloy.

In an embodiment, the bit tip is made of polycrystalline diamond.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of a preferred embodiment of the present invention;

FIG. 2 is an enlarged view of the preferred embodiment of the present invention, showing the connection of the shank and the cutting part;

FIG. 3 is an enlarged view of the preferred embodiment of the present invention, showing the bit tip; and

FIG. 4 is a sketch diagram of the preferred embodiment of the present invention, showing how the mini cutting bit work.

### DETAILED DESCRIPTION OF THE INVENTION

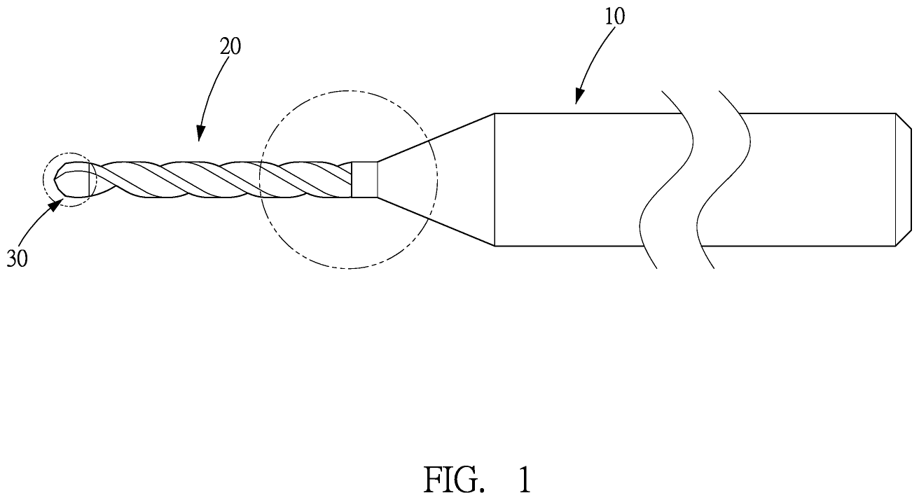

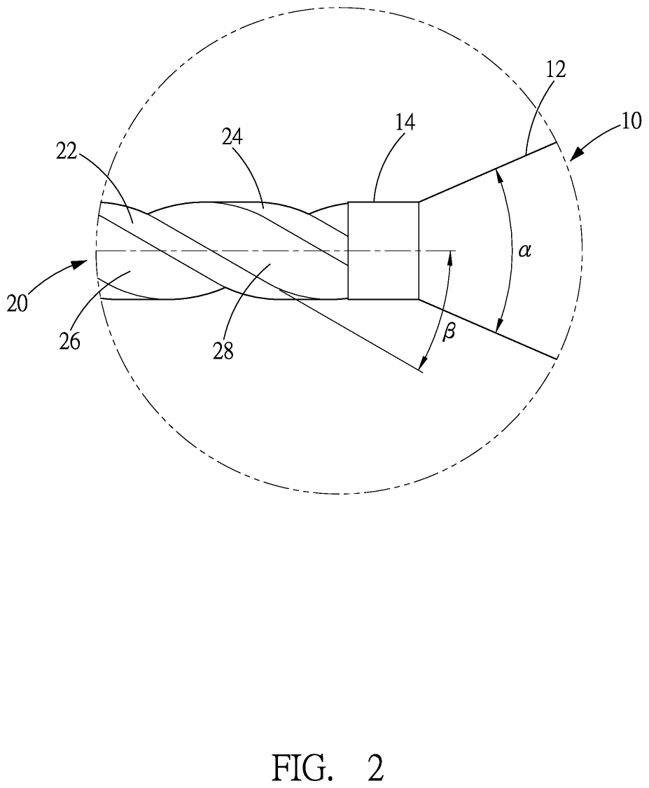

As shown in FIG. 1 and FIG. 2, a mini cutting bit of the preferred embodiment of the present invention includes a shank 10, a cutting part 20, and a bit tip 30.

The shank 10 is a round shaft having an end connected to the cutting part 20. The shank 10 has a conical portion 12 and a pillar portion 14 adjacent to the cutting part 20. The pillar portion 14 has opposite ends connected to the cutting part 20 and the conical portion 12 to increase a strength of the connection of the shank 10 and the cutting part 20. A diameter of the pillar portion 14 is substantially identical to that of the cutting part 20, and a diameter of the conical portion 12 gradually increases from an end connected to the pillar portion 14. The conical portion 12 has a taper angle α, and the taper angle α is 47 degrees in the present embodiment.

The cutting part 20 has a spiral structure with an end connected to the pillar portion 14. A diameter of the cutting part 20 is smaller than that of the shank 10. The cutting part 20 has a first spiral portion 22 and a second spiral portion 24 parallelly and twistedly formed on the cutting part 20. A helix angle β is defined as an angle between an axial direction and a helix direction of the first spiral portion 22 (see FIG. 2). The helix angle β may reduce a friction between tops of the first and the second spiral portions 22 and 24 and a workpiece (not shown). In an embodiment, the helix angle β is 32 degrees. The cutting part 20 further has a first chip removal flute 26 and a second chip removal flute 28 between the first and the second spiral portions 22 and 24 respectively. The first and the second chip removal flutes 26 and 28 are parallelly and twistedly formed on the cutting part 20 as well. The first and the second chip removal flutes 26 and 28 are designed to eject chips in the cutting task. In an embodiment, the cutting part 20 and the shank 10 are made into a single element, and they are made of tungsten carbide alloy.

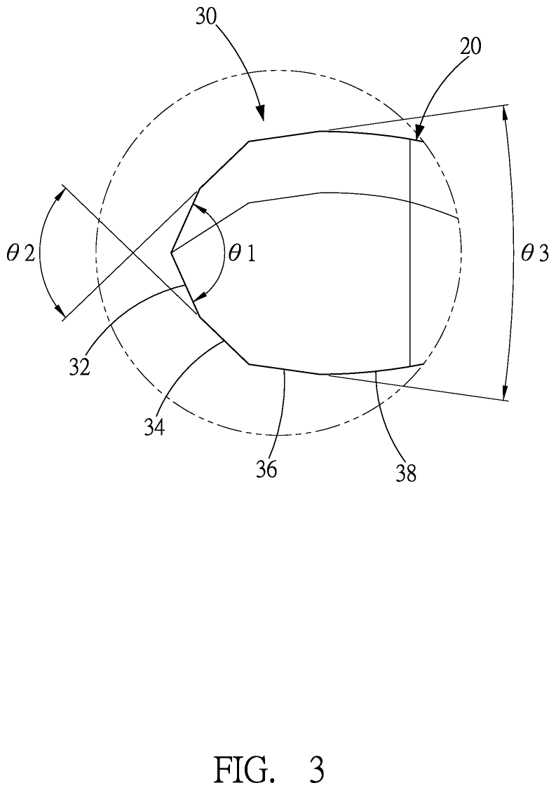

As shown in FIG. 3, the bit tip 30 is connected to an end of the cutting part 20 opposite to the shank 10. The bit tip 30 is provided with a first tip spiral portion, a second tip spiral portion, a first tip chip removal flute, and a second tip chip removal flute, which are connected to ends of the first and the second spiral portions 22 and 24 and the first and the second chip removal flutes 26 and 28 of the cutting part 20 respectively to be extensions thereof. The bit tip 30 has a first cutting portion 32, a second cutting portion 34, and a third cutting portion 36. The first cutting portion 32 is located at a center of the bit tip 30, and is proximal to a front end of the bit tip 30 than the second and the third cutting portions 34 and 36. The second cutting portion 34 is behind the first cutting portion 32 and surrounds the first cutting portion 32 while the third cutting portion 36 is behind the second cutting portion 34 and surrounds the second cutting portion 34. The first cutting portion 32 has a first cutting angle θ₁, which is an included angle between two opposite edges of the first cutting portion 32. In the same definition, the second cutting portion 34 has a second cutting angle θ₂, and the third cutting portion 36 has a third cutting angle θ₃. In an embodiment, the first cutting angle θ₁ is greater than the second cutting angle θ₂, and the second cutting angle θ₂ is greater than the third cutting angle θ₃ to form the bit tip 30 a ball-like member. In an embodiment, the first cutting angle θ₁ is 137 degrees, the second cutting angle θ₂ is 92 degrees, and the third cutting angle θ₃ is 25 degrees. The bit tip 30 further has a connecting portion 38, which has opposite ends connected to the third cutting portion 36 and the cutting part 20. A diameter of the connecting portion 38 gradually reduces from the third cutting portion 36 to the cutting part 20. The bit tip 30 and the cutting part 20 are made of different materials, and the bit tip 30 is harder than the cutting part 20. In an embodiment, the bit tip 30 is made of polycrystalline diamond (PCD) formed by high-temperature sintering and shaped by laser cutting. The bit tip 30 is connected to the cutting part 20 by vacuum welding. In another embodiment, the bit tip 30 is made of diamond or cubic boron nitride (CBN), which are harder than tungsten carbide (the material of cutting part 20).

Above description is the structure of the mini cutting bit of the present embodiment, and how the mini cutting bit work is described hereafter.

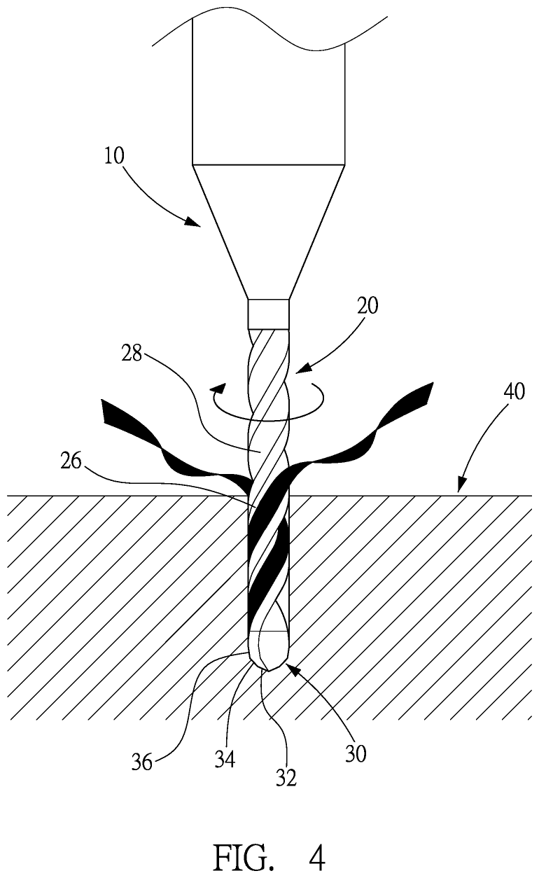

As shown in FIG. 4, the shank 10 is connected to a spindle (not shown) of a machine tool to be driven to turn the mini cutting bit, so that the bit tip 30 and the cutting part 20 may cut a workpiece 40. Since the bit tip 30 is made of PCD, which is superhard and has a superior wear resistance and impact resistance, therefore the mini cutting bit may cut a workpiece in a higher speed than the conventional cutting bit. Besides, the superhard bit tip 30 may cut a workpiece harder than conventional cutting bit may, so it has a wider application and long product's life. The first, second and third cutting portions 32, 34 and 36 may shorten the time of a cutting task and generates finer chip in the task to increase the function of the first and the second chip removal flutes 26 and 28 that may reduce the risk of damaging the cutting bit by the chip. Furthermore the mini cutting bit of the preferred embodiment may reduce the burr of the workpiece in the task as well. In conclusion, the mini cutting bit of the preferred embodiment may provide an efficient cutting task and elongate the life of the bit.

In conclusion, the mini cutting bit of the preferred embodiment provides the bit tip 30 (made of PCD), which is harder than the cutting part 20, to increase the hardness, the wear resistance and that impact resistance that may reduce the risk of damaging the mini cutting bit and elongate the product's life. In addition, the first, second and third cutting portions 32, 34 and 36 of the bit tip 30 may generate finer chip and less burr in the task to reduce the risk of damaging the mini cutting bit by the chip and elongate the product's life.

It must be pointed out that the embodiments described above are only some preferred embodiments of the present invention. All equivalent structures which employ the concepts disclosed in this specification and the appended claims should fall within the scope of the present invention.

What is claimed is:

1. A mini cutting bit, comprising:
a shank;
a cutting part connected to an end of the shank; and
a bit tip connected to an end of the cutting part opposite to the shank, wherein the bit tip and the cutting part are made of different materials, and the bit tip is harder than the cutting part.

2. The mini cutting bit of claim 1, wherein the bit tip has a first cutting portion and a second cutting portion; the first cutting portion is connected to an end of the second cutting portion and is proximal to a front end of the bit tip than the second cutting portion; the first cutting portion has a first cutting angle while the second cutting portion has a second cutting angle; the first cutting portion is greater than the second cutting angle.

3. The mini cutting bit of claim 2, wherein the first cutting angle is 137 degrees, and the second cutting angle is 92 degrees.

4. The mini cutting bit of claim 2, wherein the bit tip further has a third cutting portion connected to an end of the second cutting portion opposite to the first cutting portion; the third cutting portion has a third cutting angle, and the second cutting angle is greater than the third cutting angle.

5. The mini cutting bit of claim 4, wherein the second cutting angle is 92 degrees.

6. The mini cutting bit of claim 1, wherein the shank has a conical portion, and the conical portion has a taper angle; the taper angle is 47 degrees.

7. The mini cutting bit of claim 1, wherein the cutting part has a first spiral portion and a second spiral portion parallelly and twistedly formed on the cutting part; the first spiral portion has a helix angle, and the helix angle is 32 degrees.

8. The mini cutting bit of claim 1, wherein the shank and the cutting part are made of a single element.

9. The mini cutting bit of claim 8, wherein the cutting part and the shank are made of tungsten carbide alloy.

10. The mini cutting bit of claim 1, wherein the bit tip is made of polycrystalline diamond.
